(19) United States
(12) Patent Application Publication
(10) Pub. No.: US 2021/0322870 A1
(43) Pub. Date: Oct. 21, 2021

(54) SYSTEM AND METHOD FOR RECOGNIZING SENSE IN VIRTUAL REALITY SPACE

(71) Applicant: WAVE COMPANY CO., LTD., Seoul (KR)

(72) Inventors: Na-Yun CHO, Seoul (KR); Sang-Chul LEE, Seoul (KR); Ji-Hun HAN, Seoul (KR)

(73) Assignee: WAVE COMPANY CO., LTD.

(21) Appl. No.: 17/361,380

(22) Filed: Jun. 29, 2021

Related U.S. Application Data
(63) Continuation of application No. PCT/KR2020/000013, filed on Jan. 2, 2020.

(30) Foreign Application Priority Data
Jan. 3, 2019 (KR) 10-2019-0000655

(51) Int. Cl. A63F 13/285; A63F 13/428; A63F 13/65; A63F 13/837; G06F 1/16

(52) U.S. Cl. CPC A63F 13/285; A63F 13/428; A63F 13/65; A63F 2300/8082; G06F 1/163; A63F 2300/8076; A63F 13/837

(57) ABSTRACT

Disclosed is a sense recognition system configured to recognize, with a realistic sense, an event that occurs to a user in a virtual reality. The system comprises: a computer apparatus in which an application that is executed in a virtual reality is installed; a suit which is worn by a user while the application is executed and which has a plurality of separate electroconductive line patterns and electrodes connected thereto; and a current applying apparatus which is connected to the computer apparatus via communication and applies currents to the electrodes, wherein the current applying apparatus generates a current having a waveform matching a cutaneous sense corresponding to an event occurring during execution of the application in the virtual reality, and then applies the current to an electrode selected from among the electrodes.

### REFERENCE TO RELATED APPLICATIONS

This is a continuation of International Patent Application PCT/KR2020/000013 filed on Jan. 2, 2020, which designates the United States and claims priority of Korean Patent Application No. 10-2019-0000655 filed on Jan. 3, 2019, the entire contents of which are incorporated herein by reference.

### FIELD OF THE INVENTION

The present invention relates to a system and a method for perceiving a sensation in a virtual reality space.

### BACKGROUND OF THE INVENTION

Virtual reality or augmented reality are the generic terms for an interface or the like between a human and a computer, which manufactures a particular environment or situation as three-dimensional contents having a three-dimensional effect so as to allow a person who uses the three-dimensional contents to feel like interacting with his or her real surroundings and environments.

In addition to generalization of the above virtual reality technology and three-dimensional contents, a variety of digital devices configured to provide virtual reality services with a higher immersion level have been developed.

For example, a head-mounted display (HMD) is applied so as to display three-dimensional contents and output a sound, a suit to which a sensor is attached is applied so as to allow a user to input a command, and a control method of perceiving a motion of a user through a physical sensor is provided as disclosed in Korean Patent Registration No. 1656025.

Also, a digital tactile such as vibrations may be perceived through, for example, a touch screen, a mouse, or a suit worn on by a user according to haptic technology.

However, digital tactile is still limited to vibrations and it is impossible to output, for example, a sensation felt by a user executing a shooting game such as a first-person shooter (FPS) in a virtual reality space when the user feels a sensation of being shot. In other words, there have been no methods of allowing a cutaneous sensation such as pain or tickle which occurs in virtual reality to be felt realistically.

### SUMMARY OF THE INVENTION

The present invention is directed to providing a sensory perception system configured to allow a user to realistically perceive a sensation of an event which occurs to the user in virtual reality.

The present invention is directed to providing a sensory perception system configured to easily implement a realistic sensation corresponding to a type and a magnitude of an event.

One aspect of the present invention provides a sensory perception system in a virtual reality space. The sensory perception system includes a computer device in which an application executed in virtual reality is installed, a suit worn on a user while the application is executed and including a plurality of separate electro-conductive line patterns and electrodes connected thereto, and a current applying device configured to communicate with and be connected to the computer device and to apply a current to the electrode. Here, the current applying device generates a current having a waveform matched with a cutaneous sensation corresponding to an event occurring while the application is executed in virtual reality and applies the current to an electrode selected from the electrodes.

The computer device may include a position mapping portion configured to map a physical position of a user object of the application with a position of the electrode of the suit and store the mapped positions in a database, an event analysis portion configured to analyze an event occurring to the user object in the application and to determine the physical position of the user object where the event occurs, a code extraction portion configured to extract an event code and an electrode code of the electrode of the suit which is mapped with the physical position of the user object from the database on the basis of analysis information determined by the event analysis portion, and a main control portion configured to control execution of the application and operations of the respective portions.

The current applying device may include an electrode position determination portion configured to encode and store the electrodes installed in the suit and to select a particular electrode on the basis of the electrode code of the suit which is received from the computer device, a waveform generation portion configured to perform filtering so as to allow a current having a particular waveform to be generated from a battery on the basis of the event code received from the computer device, and a control portion configured to apply the generated current having the particular waveform to the electrode selected by the electrode position determination portion.

The computer device and the current applying device may be implemented while being integrated as a single device.

Another aspect of the present invention provides a sensory perception method in a virtual reality space, which is applied to a sensory perception system in a virtual reality space, including a computer device in which an application executed in virtual reality is installed, a suit worn on a user while the application is executed and including a plurality of separate electro-conductive line patterns and electrodes connected thereto, and a current applying device configured to communicate with and be connected to the computer device and to apply a current to the electrode. The method includes determining, when an event occurs to a user object while the application of the computer device is executed in virtual reality, a type of the event and a physical position of the user object where the event occurs, extracting an event code and an electrode code of the electrode of the suit which is mapped with the physical position of the user object from the database on the basis of a result of the determining, transmitting, by the computer device, the extracted event code and electrode code to the current applying device, filtering to allow a current having a particular waveform to be generated from a battery on the basis of the event code received by the current applying device from the computer device and selecting a particular electrode on the basis of the electrode code of the suit which is received from the computer device, and allowing the user object to feel a cutaneous sensation caused by the event by applying the current having the particular waveform to the selected electrode.

According to the present invention, a cutaneous sensation corresponding to an event occurring to a user in a game application executed in virtual reality may be realistically transferred to the user so as to allow the user to feel a game execution effect vividly.

Also, a virtual cutaneous sensation may be matched with a current waveform so as to allow the sensation to be easily perceived.

In addition, strength of an event may be realistically implemented easily by adjusting current intensity.

### BRIEF DESCRIPTION OF THE DRAWINGS

FIG. 1 is a configuration diagram illustrating a sensory perception system according to the present invention.

FIG. 2 is a functional block diagram of a computer device.

FIG. 3 is a functional block diagram of a current applying device.

FIG. 4 is a flowchart illustrating a sensory perception method according to the present invention.

### DETAILED DESCRIPTION OF THE INVENTION

It should be noted that the technical terms used herein are intended to describe a particular embodiment and the present invention is not limited thereto. In addition, the technical terms used herein, unless defined otherwise particularly, should be construed as meanings generally understood by one of ordinary skill in the art and not be construed as being excessively comprehensive meanings or excessively dismissed meanings.

Hereinafter, in order to describe a system and method for sensory perception according to the present invention, a first-person shooter (FPS) that is a type of shooting game will be described as an example. Here, as well known, FPS refers to a game in which a combat is performed using a weapon or tool in a screen like in a first-person perspective.

However, the present invention is not limited thereto and is applicable to all types of applications configured to generate events which may have an influence on a cutaneous sensation of a user.

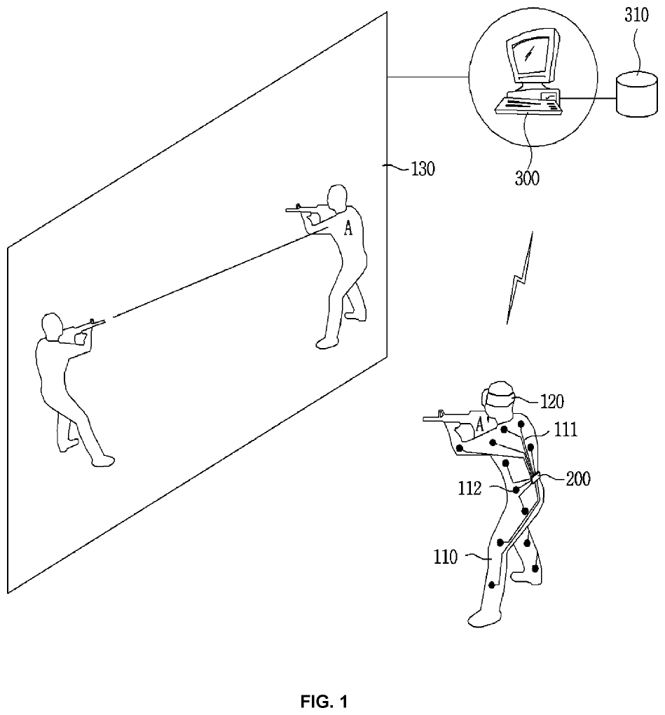

FIG. 1 is a configuration diagram illustrating a sensory perception system according to the present invention.

The sensory perception system includes a suit 110 including an electro-conductive line pattern 111 and an electrode 112, a current applying device 200, and a computer device 300.

The suit 110 is clothes worn by a user who uses a virtual reality device and is manufactured using, for example, clothing fabrics and includes the electro-conductive line pattern 111 formed on an inner surface thereof.

The line pattern 111 may be formed of an electro-conductive silicone rubber layer and is a binder formed by mixing a silicone resin with conductive powder to include high electrical conductivity and an adhesive force with the fabrics so as to tolerate bending and pulling of the suit 110 and to maintain electrical conductivity.

Accordingly, due to high viscosity, elasticity, and flexibility of the electro-conductive silicone rubber layer included in the line pattern 111, the suit 110 may be conveniently washed and the suit 110 is prevented from being damaged after washing.

A plurality of such line patterns 111 are formed to have one end electrically connected to a current applying device 200 and other end on which the electrode 112 that is an electro-conductive pad or a metal snap is formed.

As described below, the electrode 112 performs a function of transferring a cutaneous sensation corresponding to an event occurring in an executed program to the skin of a human body.

An FPS program is installed in the computer device 300, a database 301 related to the FPS program is provided, and all types of event information pieces which have an influence on a corresponding user are stored in the database 301.

The computer device 300 may be a general compatible window-based computer or may be a device including an operating system particularly applicable to the present invention and is commonly called computer device.

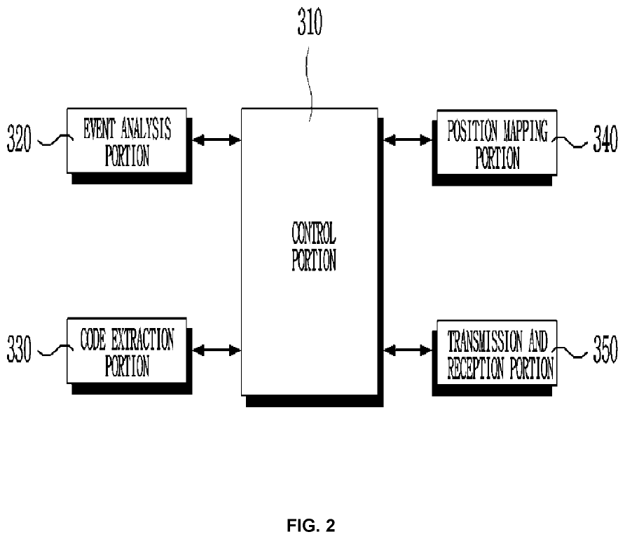

FIG. 2 is a functional block diagram of the computer device.

A position mapping portion 340 maps a physical position of a user object of an FPS with a position of the electrode 112 of the suit 110 and stores the mapped positions in the database 301.

As described below, since a position of each electrode 112 connected to the current applying device 200 is specified, the position mapping portion 340 receives corresponding position information and maps a physical position of the user object which is provided by the FPS.

Here, it is necessary to consider density of such electrodes 112 installed in the suit 110. Although there is no problem when the physical position of the user object provided by the FPS is matched with the position of the electrode 112 one by one, it is necessary to map a plurality of such physical positions of the user object to correspond to the position of one electrode 112 when the physical positions of the user object provided by the FPS are denser.

An event analysis portion 320 performs a function of analyzing an event occurring to the user in the FPS and determines a type of the event and a physical position of the user object where the event occurs.

For example, as shown as a screen in FIG. 1, when the user is shot in a left shoulder part by an opponent in the FPS, the event analysis portion 320 detects a position of a gunshot wound from facts in which a type of the event is a gunshot wound and a physical position of the user object is the shoulder part.

Additionally, the FPS may designate the extent (e.g. strength) of gunshot wound so as to classify gun-shot strength information into high, intermediate, and low.

A code extraction portion 330 extracts an event code and an electrode code of the suit 110 which is mapped with the physical position of the user object from the database 301 on the basis of analysis information provided by the event analysis portion 320 according to a request of a control portion 310.

A transmission and reception portion 350 transmits the event code and the electrode code of the suit which are extracted according to the request of the control portion 310 to the current applying device 200.

The control portion 310 may be a microprocessor and controls execution of the FPS and operations of the respective portions 320, 330, 340, and 350.

The FPS executed by the computer device 300 may be displayed on a large-screen display 130 or may be displayed on a head-mounted display (HMD) 120 with which the user is equipped.

The current applying device 200 is connected to the computer device 300 through wires or short-range wireless communications such as radio frequency (RF), Wi-Fi, Bluetooth, and the like.

The current applying device 200 may be configured to be worn around a waist like a belt or to be worn on a wrist like a watch.

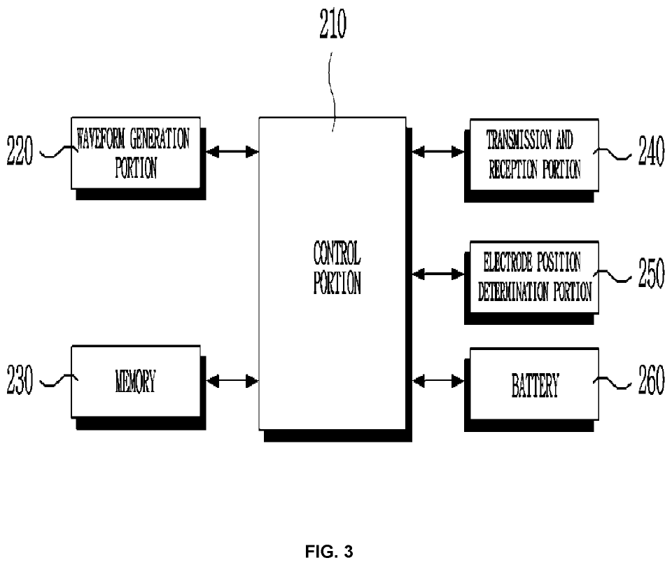

FIG. 3 is a functional block diagram of the current applying device.

An electrode position determination portion 240 encodes and stores the electrode 112 installed in the suit 110 in a memory 230 and transmits an electrode position code to the computer device 300 as described above so as to allow the position mapping portion 340 to map the physical position of the user object provided by the FPS with the position of the electrode 112 of the suit 110.

A waveform generation portion 220 performs filtering so that a current having a particular waveform is generated from a battery 260 on the basis of the event code received from the computer device 300.

The electrode position determination portion 240 selects a particular electrode among the electrodes 112 stored in the memory 230 on the basis of the electrode code of the suit which is received from the computer device 300.

A control portion 210 may be a microprocessor and applies a current having a particular waveform to the electrode 112 selected by the electrode position determination portion 240 so as to allow the user to feel a sensation in a corresponding body part.

Hereinafter, a sensory perception method according to the present invention will be described in detail with reference to FIGS. 1 to 4.

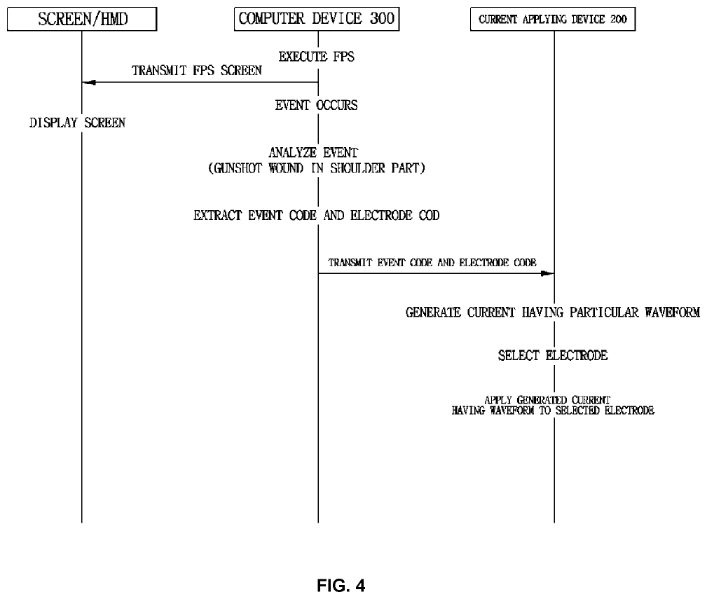

FIG. 4 is a flowchart illustrating the sensory perception method according to the present invention.

To be easily understood, the present invention will be described while being limited to a process in which when a user gets a gunshot wound in a shoulder part while wearing the suit 110 and the HMD 120 and executing an FPS installed in the computer device 300 in virtual reality, the user feels pain corresponding to the gunshot wound in the shoulder part.

When an event of getting a gunshot wound in a shoulder part by shooting of an opponent while an FPS is executed occurs, the event analysis portion 320 of the computer device 300 may determine a type of the event to be “the gunshot wound” and a physical position of a user object of the FPS to be “the shoulder part” and may further determine strength of the gunshot wound.

The code extraction portion 330 extracts an event code and an electrode code of the suit which is mapped with the physical position of the user object from the database 301 on the basis of analysis information determined by the event analysis portion 320 according to a request of the control portion 310.

The control portion 310 of the computer device 300 transmits an event code and an electrode code which are extracted through the transmission and reception portion 350 to the current applying device 200.

The waveform generation portion 220 of the current applying device 200 performs filtering so that a current having a particular waveform is generated from a battery 260 on the basis of the event code received from the computer device 300.

Waveforms of currents applied from the battery 260 may include a square wave, a sawtooth wave, a sine wave, a pulse wave, or a combination thereof through filtering or may include a symmetrical shape, an asymmetrical shape, a monophasic shape, or a biphasic shape.

The waveforms of currents may be provided through a plurality of tests to correspond to a variety of sensation types felt by a human body such as pain, stinging, tickle, irritation, and the like.

Here, as described above, the extent (strength) of the gunshot wound may be additionally transmitted and intensity of the current may be adjusted so as to generate a current having a level corresponding to the strength of the gunshot wound.

Also, the electrode position determination portion 240 selects a particular electrode among the electrodes 112 stored in the memory 230 on the basis of the electrode code of the suit which is received from the computer device 300.

As described above, when a current having a particular waveform is generated and the electrode 112 is selected, the control portion 210 applies the current having the particular waveform to the selected electrode 112 so as to allow the user to feel pain of the gunshot wound in the shoulder part.

As described above, current intensity may be increased when the strength of the gunshot wound is high so as to allow the user to feel more pain and may be decreased when the strength is low so as to allow the user to feel less pain.

In the above embodiment, although the sensory perception system including the current applying device 200 and the computer device 300 which are separated has been described as an example, the present invention is not limited thereto. For example, when the current applying device 200 includes a microprocessor and an operating system installed therein, the current applying device 200 may absorb a function of the computer device 300 and be implemented as a single integrated device.

Although the embodiment of the present invention has been described above, a variety of modifications may be made by those skilled in the art. Accordingly, the scope of the present invention should not be construed as being limited to the embodiment and should be construed through the following claims.

Since a sensory perception system according to the present invention may be applied to a game suit and may realistically transfer a cutaneous sensation corresponding to an event occurring to a user in a game application executed in virtual reality to the user so as to allow the user to feel a game execution effect vividly, the industrial applicability thereof is high.

1. A sensory perception system in a virtual reality space, comprising a computer device in which an application executed in virtual reality is installed, a suit worn on a user while the application is executed and comprising a plurality of separate electro-conductive line patterns and electrodes connected thereto, and a current applying device configured to communicate with and be connected to the computer device and to apply a current to the electrode,
wherein the current applying device transfers a current having a waveform and an intensity corresponding to a cutaneous sensation matched with an event occurring in the virtual reality while the application is executed to the skin of a human body through the plurality of separate electro-conductive line patterns and electrodes, and
wherein the waveform of the current corresponds to a type of the cutaneous sensation, and the intensity of the current corresponds to a strength of the cutaneous sensation.

2. The sensory perception system of claim 1, wherein the computer device comprises:
a position mapping portion configured to map a physical position of a user object of the application with a position of the electrode of the suit and store the mapped positions in a database;
an event analysis portion configured to analyze an event occurring to the user in the application and to determine a type of the event and the physical position of the user object where the event occurs;
a code extraction portion configured to extract an event code and an electrode code of the electrode of the suit which is mapped with the physical position of the user object from the database on the basis of analysis information determined by the event analysis portion; and
a main control portion configured to control execution of the application and operations of the respective portions.

3. The sensory perception system of claim 1, wherein the current applying device comprises:
an electrode position determination portion configured to encode and store the electrodes installed in the suit and to select a particular electrode on the basis of the electrode code of the suit which is received from the computer device;
a waveform generation portion configured to perform filtering so as to allow a current having a particular waveform to be generated from a battery on the basis of the event code received from the computer device; and
a control portion configured to apply the generated current having the particular waveform to the electrode selected by the electrode position determination portion.

4. The sensory perception system of claim 1, wherein the computer device and the current applying device are implemented while being integrated as a single device.

5. A sensory perception method in a virtual reality space, which is applied to a sensory perception system in a virtual reality space, comprising a computer device in which an application executed in virtual reality is installed, a suit worn on a user while the application is executed and comprising a plurality of separate electro-conductive line patterns and electrodes connected thereto, and a current applying device configured to communicate with and be connected to the computer device and to apply a current to the electrode, the method comprising:
determining, when an event occurs to a user in virtual reality while the application of the computer device is executed, a type of the event and a physical position of a user object where the event occurs;
extracting an event code and an electrode code of the electrode of the suit which is mapped with the physical position of the user object from the database on the basis of a result of the determining;
transmitting, by the computer device, the extracted event code and electrode code to the current applying device;
filtering to allow a current having a particular waveform and an intensity to be generated from a battery on the basis of the event code received by the current applying device from the computer device and selecting a particular electrode on the basis of the electrode code of the suit which is received from the computer device; and
allowing the user to feel a cutaneous sensation of a type and an intensity corresponding to the event by applying the current having the particular waveform and the intensity to the selected electrode.
